(19) United States
(12) Patent Application Publication
(10) Pub. No.: US 2017/0314753 A1
(43) Pub. Date: Nov. 2, 2017

(54) LIGHTING DEVICE FOR EMITTING ILLUMINATION LIGHT

(71) Applicant: OSRAM GmbH, Munich (DE)

(72) Inventors: Christian Gammer, Traitsching (DE); Sergey Khrushchev, Regensburg (DE)

(21) Appl. No.: 15/484,154

(22) Filed: Apr. 11, 2017

(30) Foreign Application Priority Data
Apr. 28, 2016 (DE) 10 2016 207 224.2

(51) Int. Cl. F21S 8/10; B60Q 1/04; F21Y 2115/30

(52) U.S. Cl. CPC F21S 48/1225; F21S 48/1394; F21S 48/1241; F21S 48/1145; B60Q 1/04; B60Q 2400/30; F21Y 2115/30

(57) ABSTRACT

A lighting device for emitting illumination light includes an LED configured to emit light emitting diode radiation, a laser configured to emit laser radiation, and a phosphor element configured to at least partly convert the LED radiation and the laser radiation into a conversion light which at least proportionally forms the illumination light. The LED, the laser and the phosphor element are arranged relative to one another in such a way that during the operation of the lighting device on an incidence surface of the phosphor element in each case in the time integral the LED irradiates an LED irradiation surface with the light emitting diode radiation and the laser irradiates a laser irradiation surface with the laser radiation. The laser irradiation surface and the LED irradiation surface are free of overlap.

### CROSS-REFERENCE TO RELATED APPLICATION

This application claims priority to German Patent Application Serial No. 10 2016 207 224.2, which was filed Apr. 28, 2016, and is incorporated herein by reference in its entirety.

### TECHNICAL FIELD

Various embodiments relate generally to a lighting device for emitting illumination light, said lighting device having a phosphor element.

### BACKGROUND

In lighting devices of the type that is relevant in the present case, a phosphor element is irradiated with a pump radiation. The phosphor element converts the pump radiation into a conversion light which then at least proportionally forms the illumination light emitted by the lighting device. In the case of a so-called partial conversion, the conversion light together with a non-converted portion of pump radiation can form the illumination light, wherein then e.g. blue pump light may be provided as pump radiation. On the other hand, however, the conversion light alone can also form the illumination light (full conversion).

### SUMMARY

A lighting device for emitting illumination light includes an LED configured to emit light emitting diode radiation, a laser configured to emit laser radiation, and a phosphor element configured to at least partly convert the LED radiation and the laser radiation into a conversion light which at least proportionally forms the illumination light. The LED, the laser and the phosphor element are arranged relative to one another in such a way that during the operation of the lighting device on an incidence surface of the phosphor element in each case in the time integral the LED irradiates an LED irradiation surface with the light emitting diode radiation and the laser irradiates a laser irradiation surface with the laser radiation. The laser irradiation surface and the LED irradiation surface are free of overlap.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a first lighting device according to various embodiments including a phosphor element irradiated by LED and laser in combination, at which phosphor element an illumination optical unit including a solid-body optical waveguide, a reflector and a converging lens is provided;

FIG. 2 shows a second lighting device according to various embodiments including a phosphor element irradiated by LED and laser in combination, at which phosphor element an illumination optical unit including reflector and converging lens is provided; and

FIG. 3 shows the phosphor element of the lighting device in accordance with FIG. 2 in a plan view, wherein a laser irradiation surface and LED irradiation surfaces can be discerned.

### DESCRIPTION

The invention is explained in greater detail below on the basis of embodiments, wherein the individual features in the context of the alternative independent claims may also be essential to the invention in a different combination, and also no distinction is furthermore drawn specifically between the claim categories.

The following detailed description refers to the accompanying drawings that show, by way of illustration, specific details and embodiments in which the invention may be practiced.

Various embodiments address the technical problem of specifying a particularly advantageous lighting device.

According to various embodiments, this problem is solved by a lighting device for emitting illumination light, incudig a light emitting diode (LED) for emitting LED radiation, a laser for emitting laser radiation, and a phosphor element for at least partly converting the LED radiation and the laser radiation into a conversion light which at least proportionally forms the illumination light. The LED, the laser and the phosphor element are arranged relative to one another in such a way that during the operation of the lighting device on an incidence surface of the phosphor element in each case in the time integral the LED irradiates an LED irradiation surface with the LED radiation and the laser irradiates a laser irradiation surface with the laser radiation. The laser irradiation surface and the LED irradiation surface are free of overlap.

Various embodiments are found in the dependent claims and the entire disclosure, wherein in the presentation a distinction is not always drawn specifically between method and device or use aspects; the disclosure should at any rate be interpreted implicitly with regard to all claim categories.

One basic concept in the present case consists in providing not just one, but rather at least two pump radiation sources, specifically with the LED and the laser two pump radiation sources of different types. The LED radiation is emitted by the LED typically in Lambertian fashion, that is to say in a manner completely filling a half-space, but at any rate in a wide-angled fashion; by contrast, the laser radiation is narrowly focused, with the beam of rays being sharply delimited. The LED can now be used e.g. for a large-area basic illumination of the incidence surface. By contrast, the laser irradiation surface can be smaller and the irradiance there can be higher by a multiple than on the LED irradiation surface. In principle, the quantity of illumination light that is then emitted by the phosphor element from a respective surface region of its emission surface correlates with the quantity of pump radiation (LED and/or laser radiation) that is radiated into a corresponding surface region of the incidence surface. In response to the excitation with the LED radiation, therefore, illumination light is then emitted more likely over a large area, whereas in response to the excitation with the laser radiation, illumination light is emitted from a smaller area with considerably higher power density.

One possible field of application may be in the area of road illumination using a motor vehicle front headlight, see below in detail. In this case, illumination light generated by means of laser radiation (also called “laser illumination light” below for the sake of simplicity) can be used e.g. in the context of a high-beam light function on account of the high luminance. By contrast, illumination light generated by means of the LED radiation (also called “LED illumination light”) can be used e.g. as low-beam light and/or daytime running light. This is intended to illustrate one possibility opened up by various embodiments, but not to restrict the generality of the concept of the embodiments. Further possibilities for application may be lighting devices such as e.g. spotlights for architecture lighting, effect lighting, underwater lighting, signal luminaires, ship spotlights, and studio lighting.

Generally, a respective irradiation region/a respective irradiation surface may be determined according to the full width at half maximum, that is to say that the region/the surface extends on the incidence surface up to where the radiation power (of the respective radiation) has fallen to half (in general the edge could e.g. also be placed where the radiation power has fallen to 1/e or 1/e²).

The LED and laser irradiation surfaces are “free of overlap”, that is to say do not overlap, but rather lie disjointly with respect to one another on the incidence surface. In general, they may touch one another, but they may be spaced apart from one another. The combined phosphor element irradiation makes it possible e.g. to increase the integration depth, which may afford advantages e.g. regarding the space requirement or else the robustness, also with respect to mounting fluctuations.

The “phosphor element” irradiated by LED and laser is integral, that is to say that, for example, a region thereof with the LED irradiation surface cannot be separated from a region with the laser irradiation surface nondestructively, that is to say without at least partial destruction (only irreversible) of the phosphor element or of a part thereof. The “phosphor element” may be e.g. a (e.g. transparent) carrier with the phosphor thereon. The phosphor may directly adjoin the carrier and/or form a continuous layer; in general, however, it can also be connected thereto via a joining connection layer, e.g. adhesive layer.

The phosphor element may, however, e.g. also include a matrix material, e.g. a ceramic, glass, or a plastics material, in which the phosphor is arranged in a manner distributed among discrete regions, for instance formed in grains of the ceramic or in particle form in glass/plastic. The phosphor element may furthermore also be a monocrystal of the phosphor, for instance a YAG:Ce monocrystal. In the case of the at least partial destruction discussed above, e.g. the single crystal, the matrix material or the carrier and/or the phosphor itself would then be locally separated.

Cerium-doped yttrium aluminum garnet (YAG:Ce) may be provided as phosphor. In general, however, “phosphor” may also be interpretable as a mixture of a plurality of individual phosphors, one of which may then be e.g. YAG:Ce. For example in the case of the laser radiation, in general a spatially variable irradiation of the incidence surface is also conceivable, that is to say that the laser irradiation surface can be scanned, for example. In this respect, a distinction is also drawn conceptually between “irradiation region” as the entire region of the incidence surface that is irradiated with the respective radiation (LED or laser) at a respective point in time (snapshot) and “irradiation surface”, wherein the latter arises in the time integral.

The LED irradiation surface thus arises as a union of all the LED irradiation regions that are irradiated in the course of the operation of the lighting device; equally, the laser irradiation surface arises as the union of all the laser irradiation regions. In other words, a respective irradiation surface is the surface irradiated overall with the respective radiation in the course of operation. In various embodiments, the LED irradiation region and/or the laser irradiation region are/is spatially invariable in the course of the operation of the lighting device if irradiation with the respective radiation is effected. A respective irradiation region (snapshot) can be switched in or out during operation, but is moreover congruent with the respective irradiation surface.

In various embodiments, the phosphor element is operated in transmission, that is to say that the incidence surface and the emission surface are opposite to one another (nevertheless the emission pattern on the emission surface and the incidence pattern on the incidence surface are substantially congruent). In general, however, operation in reflection would also be possible, that is to say that incidence surface and emission surface could also coincide (and the opposite side surface of the phosphor element could then be reflectively coated, for example). Generally, a dichroic reflective coating can be provided on the incidence surface and/or the emission surface, e.g. in the case of operation in transmission on the incidence surface a coating that is reflective for the conversion light/transmissive to the pump radiation, and/or on the emission surface a coating that is transmissive for the conversion light/reflective for the pump radiation. The conversion may be a down conversion, that is to say that the conversion light has a longer wavelength (lower energy) in comparison with the laser radiation/LED radiation.

Apart from the sharp focusing, the laser radiation may be distinguished e.g. by a high intensity or a long coherence length; both the laser radiation and the LED radiation in each case may lie in a narrow frequency range, that is to say that the radiation may be monochromatic in each case. The term “laser” may also be interpretable as an arrangement (an array) including a plurality of individual laser sources; a laser diode is preferred as individual laser source. “A plurality” means at least two, wherein at least three and at least four are further lower limits (and at most 100, 80, 60, 40, 20 or 10 may be upper limits independent thereof). The laser radiation preferably optically effectively penetrates through a gas volume, e.g. air, on its path to the incidence surface. Such a construction is also referred to as an LARP arrangement (Laser Activated Remote Phosphor).

In various embodiments, the phosphor element and the LED are provided in direct optical contact with one another, that is to say that the LED radiation therebetween penetrates through at most an intermediate material having a refractive index n≧1.2, e.g. ≧1.3 and ≧1.4 respectively. Possible upper limits may be e.g. at at most 1.8 and 1.7 (refractive indices are generally considered at a wavelength of A=589 nm). Insofar as an intermediate material is provided, this may be a joining connection material, e.g. an adhesive. In general, however, it is also conceivable for the phosphor element to be integrally formed directly on the LED (an exit surface thereof), that is to say that the LED radiation enters the phosphor element directly (without intermediate material). Independently of the configuration in specific detail, the direct optical contact may afford effects e.g. with regard to the efficiency and also concerning a compact construction.

In various embodiments, the lighting device is configured in such a way that the incidence surface during operation is only ever irradiated alternatively with the LED radiation or the laser radiation. Therefore, LED radiation and laser radiation are never incident simultaneously on the incidence surface; the irradiation thus takes place completely disjointly from a temporal standpoint. In the case of a motor vehicle headlight, therefore, for example either the daytime running light mode or the high-beam light mode, or either the low-beam light mode or the high-beam light mode is then switched on.

In general, however, a simultaneous irradiation is also possible, that is to say that irradiation could also be carried out using LED radiation e.g. in the high-beam light mode. In the case of the LED illumination light used as low beam light, the low-beam light cone or a part thereof could simply supplement the high-beam light cone. If the LED illumination light is used as daytime running light, its radiation power in the high-beam light mode may be at least reduced, for instance by at least 50%; it can be lowered e.g. to a position light level or even be completely switched off.

Insofar as mention is generally made of the fact that the lighting device (or the motor vehicle headlight) is “configured” for specific operation, this means, insofar as there is only a single operating state, that the relative arrangement of LED, laser and phosphor element (and of possible means for beam guiding, such as e.g. lenses/mirrors) is such that a corresponding irradiation is carried out when the lighting device is switched on; insofar as there are a plurality of operating states, a corresponding control unit can be provided, for example, which correspondingly changes the irradiation from one operating state to the other, e.g. by adapting the output power of the LED and/or of the laser. Reference is made to “operating state” if at least one of the sources (LED and laser) emits radiation.

In various embodiments, a plurality of LEDs are provided, each of which irradiates the incidence surface of the phosphor element in a respective LED irradiation surface with respective LED radiation (with regard to a possible quantification of “a plurality” reference is made to the above explanations concerning the individual laser sources). The LED irradiation surfaces lie on the incidence surface e.g. in a manner completely free of overlap (see above) relative to one another, that is to say that not a single one of them overlaps another. In general, however, a partial overlap is also possible, e.g. of closest adjacent LED irradiation surfaces (e.g. a solid-body optical waveguide, see below in detail, can thus be supplied by a continuous light strip even in the case of a plurality of LEDs).

In various embodiments, an arrangement of the LED irradiation surfaces is such that jointly they at least partly enclose the laser irradiation surface (in regard to a plan view, looking at the incidence surface perpendicularly). This means, for example, that connecting straight lines—lying in the incidence surface—from an area centroid of the laser irradiation surface to the LED irradiation surfaces fill a total angle range of at least 180°, 202.5°, 225°, 247.5°, 270°, 280°, 290°, 300°, 310°, 320°, 330°, 340° or 350° (with increasing preference in the order in which they are mentioned); complete enclosure (360°) may be provided. The total angle range can generally also result from a plurality of partial angle ranges in summation if the respective LED irradiation surfaces are sufficiently small/correspondingly far apart from one another (between the LED irradiation surfaces there are straight lines which proceed from the area centroid and which do not meet an LED irradiation surface). A continuous total angle range may be provided, however; for example, the laser irradiation surface is completely enclosed, that is to say that each connecting straight line proceeding from the area centroid meets one of the LED irradiation surfaces. The “area centroid” results as a geometrical area centroid, that is to say without weighting with the irradiance.

In various embodiments, the laser irradiation surface has a surface area which makes up at most 40%, with increasing preference in this order at most 35%, 30%, 25%, 20%, 15%, 10% or 5%, of the surface area of the LED irradiation surface. Possible lower limits may be e.g. at at least 0.5% or at least 1% (and may be of interest in general also independently of an upper limit).

In various embodiments, the LED irradiation surface by itself (in the case of a single LED) or the LED irradiation surfaces in total (in the case of a plurality of LEDs) has or have a surface area which makes up at least 40%, e.g. at least 45%, e.g. at least 50%, of a surface area of the incidence surface. In various embodiments, therefore, at least half of the incidence surface is irradiated with LED radiation. The “incidence surface” is that side surface of the phosphor element which includes the irradiation surfaces but for its part is not necessarily irradiated in its entirety; at an edge (e.g. cylindrical phosphor element), or edges (e.g. parallelepipedal phosphor element) said incidence surface adjoins the edge surface (lateral surface of the cylinder) or edge surfaces (side surfaces of the parallelepiped) of the phosphor element. In various embodiments, the incidence surface is planar. In various embodiments, the emission surface is also planar, also independently of the incidence surface.

In various embodiments, an illumination optical unit for guiding away the illumination light is provided on the emission surface of the phosphor element. In this case, one possible illumination optical unit is constructed functionally in multipartitate fashion, that is to say guides illumination light emitted at different locations of the emission surface in different ways. In this regard, this illumination optical unit firstly has a solid-body optical waveguide which is transmissive in its volume and in which a first part of the illumination light is guided away from the emission surface. Furthermore, the illumination optical unit has a reflector, at the reflection surface of which a second part of the illumination light is reflected. These two components are preferably integrated to the effect that the reflector is formed on a surface of the solid-body optical waveguide, that is to say that the latter itself serves for guiding light in its volume and also carries the reflector, e.g. in the form of a coating applied to the surface, e.g. a metal coating, e.g. composed of silver.

The surface of the solid body with the reflector may lie on the inner side in such a way that the reflector is embodied as a concave mirror. Therefore, “on the inner side” relates to directions pointing perpendicularly away from a chief ray of the laser illumination light toward the outside, wherein said chief ray lies in the area centroid (see above) of the laser irradiation surface and points along a main propagation direction of the laser illumination light on the emission surface. A “main propagation direction” arises generally as the average value of all direction vectors of the beam of rays of the light respectively considered/the radiation respectively considered, wherein in the course of this averaging each direction vector is weighted with the radiant intensity associated therewith. In various embodiments, the emission surface is planar (which generally holds true) and the chief ray/the main propagation direction of the laser illumination light are perpendicular thereto.

The “concave mirror” has its concave shape as viewed in sectional planes including the chief ray of the laser illumination light. The reflection surface may be e.g. spherical or ellipsoidal, but may also have a paraboloidal or hyperboloidal shape; it may also be shaped in a freeform fashion, that is to say that e.g. as viewed in said sectional planes on both sides of the chief ray said reflection surface may be curved concavely in each case, but may in this case not correspond to a conic section.

The second part of the illumination light, said second part being reflected at the reflector, is “focused” with the reflection. A beam of rays including the second part of the illumination light thus has a smaller aperture angle downstream of the reflector compared with upstream, for example smaller by at least 30%, 60% or 90% (with increasing preference in the order in which they are mentioned); for example, it is collimated downstream of the reflector (aperture angle of 0°, within the scope of what is technically possible). Technical dictates mean that upper limits may be e.g. at 99.9% or 99.5%. In the case of an aperture angle that varies relative to a circulation, an average value formed over the circulation is considered in each case (upstream and downstream of the reflector).

An entrance surface of the solid-body optical waveguide faces the emission surface of the phosphor element; it may be provided in direct optical contact therewith (e.g. connected thereto by means of adhesive as intermediate material, cf. also the other definitions above concerning “direct optical contact”). From said entrance surface, the first part of the illumination light is guided in the volume of the optical waveguide solid body to an opposite exit surface. For this purpose, in general an exterior surface of the solid body could also additionally be reflectively coated, but light guidance by total internal reflection may be provided. The solid body may generally e.g. also be provided from a plastics material, for instance polycarbonate or polymethyl methacrylate; glass may be provided, also on account of the thermal stability.

In various embodiments, the illumination optical unit (including optical waveguide solid body and reflector) additionally has a converging lens, through which a third part of the illumination light, said third part being emitted at the emission surface at smaller emission angles than the second reflected part, penetrates and is focused in the process. In general, the converging lens could also extend as far as the reflector relative to the directions perpendicular to the chief ray (see above) and the second part of the illumination light would then correspondingly also penetrate through said converging lens. In various embodiments, said converging lens does not extend as far as the reflector, that is to say that there is a gap between them, through which gap the illumination light reflected at the reflector goes past the converging lens at least proportionally laterally. The third part of the illumination light is focused by the converging lens, that is to say that a corresponding beam of rays has a smaller aperture angle downstream of the converging lens compared with upstream (with regard to a possible quantification of “focused”, reference is made to the above disclosure concerning the reflector).

The converging lens has at least one curved light exit surface at which the third part of the illumination light is refracted and focused in the course of exiting. The opposite light entrance surface can also be embodied in a planar fashion and/or be provided in direct optical contact (see definition above) with the emission surface of the phosphor element. In this respect, the converging lens may thus also be a solid body placed onto the phosphor element. In various embodiments, the second part of the illumination light, said second part being guided via the reflector, then also penetrates through said solid body, but exits at a planar exit surface thereof, that is to say not through the curved exit surface of the converging lens. An overall exit surface of the solid-body converging lens may thus be e.g. marginally planar and centrally convexly curved; only centrally does the solid body then act as a converging lens.

In various embodiments, the solid-body converging lens adjoins the reflector laterally, relative to the directions perpendicular to the chief ray. A side wall of the solid-body converging lens may generally also itself be reflectively coated, that is to say may for its part carry the reflector (e.g. also in the case of the illumination optical unit described below, see below), but the reflection there may also be total internal reflection (TIR), such that the solid body forms a TIR converging lens.

In various embodiments, an arrangement of the converging lens relative to the reflector is such that an optical axis of the converging lens is parallel to an optical axis of the reflector, and e.g. coincides therewith. The respective optical axis is preferably in each case an axis of a rotational or circular symmetry (corresponding to the converging lens or the reflector).

In various embodiments, the first part of the illumination light, said first part being guided by the optical waveguide solid body, is generated in response to an excitation with the LED radiation (“LED illumination light”), and the second part of the illumination light is generated in response to an excitation with the laser radiation (“laser illumination light”), e.g. exclusively in each case. The third part may be likewise laser illumination light, e.g. exclusively.

Generally, the LED illumination light and/or the laser illumination light are/is e.g. generated in each case in partial conversion, said light thus in each case being composed proportionally of the conversion light and proportionally of non-converted LED radiation in the case of the LED illumination light and, respectively, proportionally of non-converted laser radiation in the case of the laser illumination light. The proportionally non-converted LED radiation and/or laser radiation here are/is generally scattered at least somewhat in the phosphor element, said radiation thus then having, downstream of the phosphor element, despite the focused incidence, at any rate in the case of the laser radiation, an aperture angle comparable to the conversion light.

Generally, the “LED” may include one light emitting diode. If a plurality of light emitting diodes are present, they may emit light in the same color or in different colors. A color may be monochromatic (e.g. red, green, blue, etc.) or multichromatic (e.g. white). A plurality of light emitting diodes may generate a mixed light; e.g. a blue mixed light. The light emitting diode may also already contain by itself, in addition to the phosphor element, a wavelength-converting phosphor (conversion LED). The light emitting diode may be present in the form of an individually packaged light emitting diode or in the form of an LED chip. A plurality of LED chips may be mounted on a common substrate (“submount”). Instead of or in addition to inorganic light emitting diodes, e.g. on the basis of InGaN or AlInGaP, organic LEDs (OLEDs, e.g. polymer OLEDs) can generally be used as well.

In various embodiments, the emission surface of the phosphor element is assigned an illumination optical unit including a concave mirror (cf the above definitions in respect thereof) as reflector, at which both LED illumination light and laser illumination light are reflected at least proportionally in each case. In various embodiments, in each case the entire respective part of the illumination light is not incident thereon, specifically not illumination light emitted at small emission angles, for example. In general, such an illumination optical unit could additionally also have a solid-body optical waveguide, at which the reflector would then preferably be provided on the inner side analogously to the description above; the solid-body optical waveguide would then be supplied with illumination light via (one) further LED or LEDs. On the other hand, it may however also be preferred for in each case at least proportionally some LED illumination light from each LED of the lighting device (in the case of a plurality of LEDs) to be guided via the reflector (and accordingly for there to be no solid-body optical waveguide).

In various embodiments, the illumination optical unit including the reflector via which both LED illumination light and laser illumination light are guided has a converging lens. Both LED illumination light and laser illumination light penetrate through said converging lens, the respective illumination light being focused in each case. With regard to the “focusing” and also the relative arrangement of converging lens and reflector (e.g. with or without a gap therebetween), reference is expressly made to the above disclosure for the illumination optical unit with solid-body optical waveguide; corresponding embodiments may be provided in the present case, too, apart from the presence of the solid-body optical waveguide. In various embodiments, preference may be given to a solid-body converging lens (see above) whose side wall is reflectively coated in order to form the reflector. The reflected part of the illumination light is then also guided through this solid body, but exits at a planar exit surface.

For all reflectors discussed in the context of this disclosure it holds true that their reflection surface may be at least rotationally symmetrical, e.g. circularly symmetrical. The solid-body optical waveguide, too, may be at least rotationally symmetrical, e.g. circularly symmetrical. A respective axis of symmetry is then identical to the respective optical axis.

The discussed embodiments including an “illumination optical unit” may generally also be of interest independently of the features of the main claim, specifically independently of a phosphor element irradiated by LED and laser in combination, and are intended additionally also to be disclosed in this regard, that is to say in conjunction with a phosphor element irradiated only with LED radiation or laser radiation. In the case of the illumination optical unit discussed first, e.g. the phosphor element could be assigned to the reflector and irradiated by a laser, wherein the solid-body optical waveguide could be supplied with (a) separate LED/LEDs, the latter thus not transmitting radiation through the phosphor element.

Various embodiments also relate to a motor vehicle headlight including a lighting device described in the present case, e.g. a front headlight and/or an automobile headlight, e.g. an automobile front headlight.

In various embodiments of the motor vehicle headlight, the latter includes a lighting device with integrated solid-body optical waveguide/reflector, wherein LED illumination light is guided away from the emission surface by the solid-body optical waveguide. The motor vehicle headlight is configured (cf. the above indications concerning “be configured”) here for operation in such a way that the LED illumination light is emitted via the solid-body optical waveguide in a daytime running light mode and thus at least supports a daytime running light function of the motor vehicle headlight. Outside the daytime running light mode, in general e.g. dimmed operation is also possible (see above); for example, LED illumination light is not emitted through the solid-body optical waveguide.

In various embodiments of the motor vehicle headlight the latter includes a lighting device with a reflector, via which both LED illumination light and laser illumination light are guided. In various embodiments, the motor vehicle headlight is configured in such a way that the LED illumination light is emitted in a low-beam light mode. In various embodiments, an illumination light emitted overall by the lighting device in the low-beam light mode propagates downstream of the illumination optical unit with a main propagation direction tilted with respect to the optical axis of the reflector by e.g. at least 5°, e.g. at least 10°, and (independently thereof) e.g. not more than 40° or 30°. This illumination light emitted “overall” in the low-beam light mode may originate from an excitation with a plurality of LEDs.

In various embodiments, the motor vehicle headlight is configured such that in a high-beam light mode, e.g. exclusively in the high-beam light mode, the laser irradiation surface is irradiated with the laser radiation. A part of the illumination light that is generated in response to this excitation is guided at least proportionally via the reflector. The illumination light thus generated supports at least one high-beam light function of the motor vehicle headlight.

In various embodiments, the illumination light which is generated in response to the excitation with the laser radiation propagates downstream of the reflector with a main propagation direction parallel to the optical axis of the reflector.

Various embodiments also relate to the use of a lighting device described in the present case for lighting purposes with a motor vehicle headlight or else the use of a motor vehicle headlight in one of the ways just described (daytime running light mode, low-beam light mode, high-beam light mode). It may generally be given to a use of the lighting device or a motor vehicle headlight therewith in which at least two light functions are combined. As an alternative or in addition to the already mentioned combination of low beam and high beam light, e.g. a daytime running light function and/or foglight function may also be integrated. By way of example, a flashing light function may also be combined with a foglight function and/or a low-beam light function. In the case of flashing light operation, e.g. only some of a plurality of LEDs that are assigned to a solid-body optical waveguide may be operated, such that light is then emitted e.g. only from half of the solid-body optical waveguide. Generally, a local boost of the luminance which is possible according to the invention can also be used for an emergency indicator, e.g. in warning flashing operation.

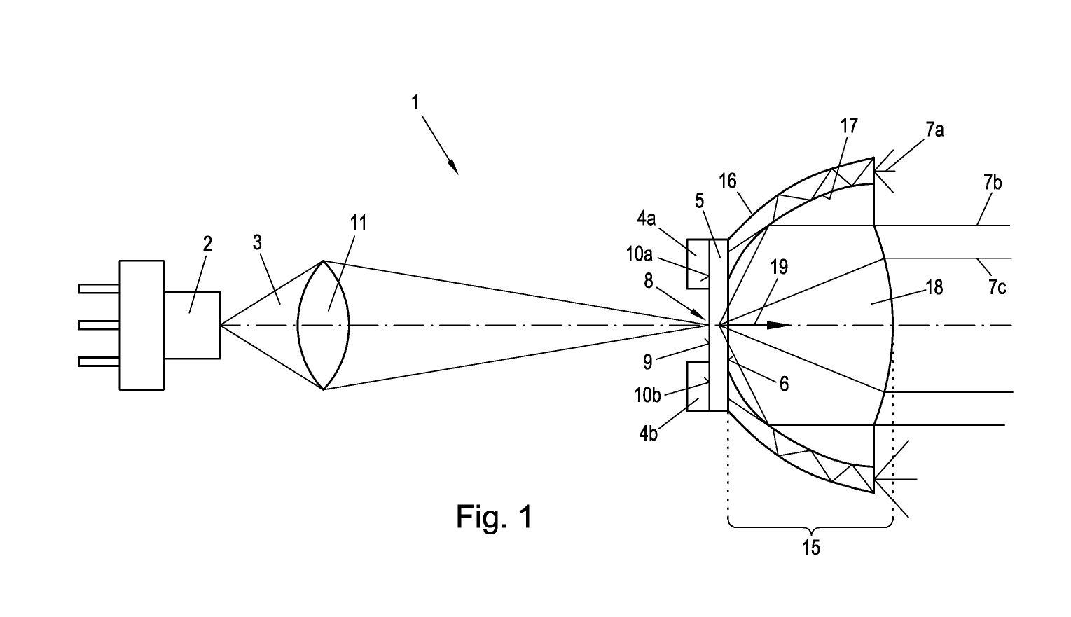

FIG. 1 shows a first lighting device 1 according to various embodiments including a laser 2, namely a laser diode, for emitting laser radiation 3 and including light emitting diodes (LEDs) 4a, b for emitting LED radiation (not illustrated). By way of example, a so-called micro-LARP source may also be provided as laser 2; as an example reference is made to DE 20 2014 001 376 U1 and DE 20 2015 001 682 U1. The LED radiation and the laser radiation 3 serve in each case as pump radiation for exciting a phosphor element 5, which emits a conversion light (not illustrated in specific detail) in response to this excitation. In the present case, the phosphor element 5 includes YAG:Ce as phosphor and the conversion light is yellow light. The pump radiation is blue light and is converted only proportionally in each case, such that an illumination light 7 emitted at an emission surface 6 of the phosphor element 5 is white light.

A laser irradiation surface 8 on an incidence surface 9 of the phosphor element 5, opposite to the emission surface 6, is irradiated with the laser radiation 3. The LED irradiation surfaces 10a, b respectively irradiated with the LED radiation are arranged on the incidence surface 9 at a distance from the laser irradiation surface 8. The power density of the laser radiation 3 is high anyway; in addition, it is guided onto the incidence surface 9 in a manner focused via an incidence converging lens 11, such that the irradiance on the laser irradiation surface 8 is higher by a multiple than that on the LED irradiation surfaces 10a, b. Accordingly, at the emission surface 6 illumination light 7 is emitted with considerably higher luminance in response to the excitation with the laser radiation 3 compared with the case of an excitation with the LED radiation.

The emission surface 6 is assigned an illumination optical unit 15 including a solid-body optical waveguide 16, a reflector 17 and a converging lens 18. The reflector 17 is applied as coating to a surface of the solid-body optical waveguide 16 which lies on the inner side relative to directions perpendicular away from a chief ray 19 (the chief ray 19 concerns that part of the illumination light 7 which is generated in response to the excitation with the laser radiation 3). In the present case, the converging lens 18 is provided as part of a solid body which has a planar light entrance surface and laterally adjoins the reflector 17. An overall light exit surface of the solid-body converging lens is centrally convexly curved (lens function) and marginally planar.

A first part 7a of the illumination light 7, said first part being generated in response to an excitation with the LED radiation, is guided by the solid-body optical waveguide 16 arranged laterally outside the solid-body converging lens. In order to supply the solid-body optical waveguide 16, on the incidence surface 9 a plurality of LEDs are arranged circumferentially around the laser irradiation surface 8, two LEDs 4a, b of which can be discerned in the sectional view in accordance with FIG. 1. If the lighting device 1 is then part of a motor vehicle headlight, the first part 7a of the illumination light 7 is emitted in a daytime running light mode.

In a high-beam light mode of the motor vehicle headlight, excitation is carried out using the laser radiation 3, wherein the excitation with the LED radiation is at least reduced, e.g. completely switched out, such that thus no illumination light 7 is then emitted via the solid-body optical waveguide 16. A second part 7b of the illumination light 7, said second part being generated in response to the excitation with the laser radiation 3, is reflected at the reflector 17 and focused in the process (in the present case, only a few rays are respectively shown generally by way of example). Although said second part 7b of the illumination light 7 propagates in the solid body of the converging lens 18, it does not participate in the lens function thereof, but rather emerges at a planar exit surface. A third part 7c of the illumination light 7, said third part likewise being generated in response to the excitation with the laser radiation 3 and being emitted at smaller emission angles in comparison with the second part 7b, penetrates through the converging lens 18, that is to say penetrates through the solid body and emerges at the convexly curved exit surface, and is focused in the process. Downstream of the illumination optical unit 15, the illumination light emitted in response to the excitation with the laser radiation 3 may be collimated in its entirety.

For the sake of simplicity, with the “daytime running light mode” and the “high-beam light mode”, two operating modes which in reality occur alternatively, that is to say sequentially from a temporal standpoint, are illustrated in a joint illustration in FIG. 1. In actual fact, either the first part 7a is guided through the illumination optical unit 15 or the second part 7b and third part 7c are emitted.

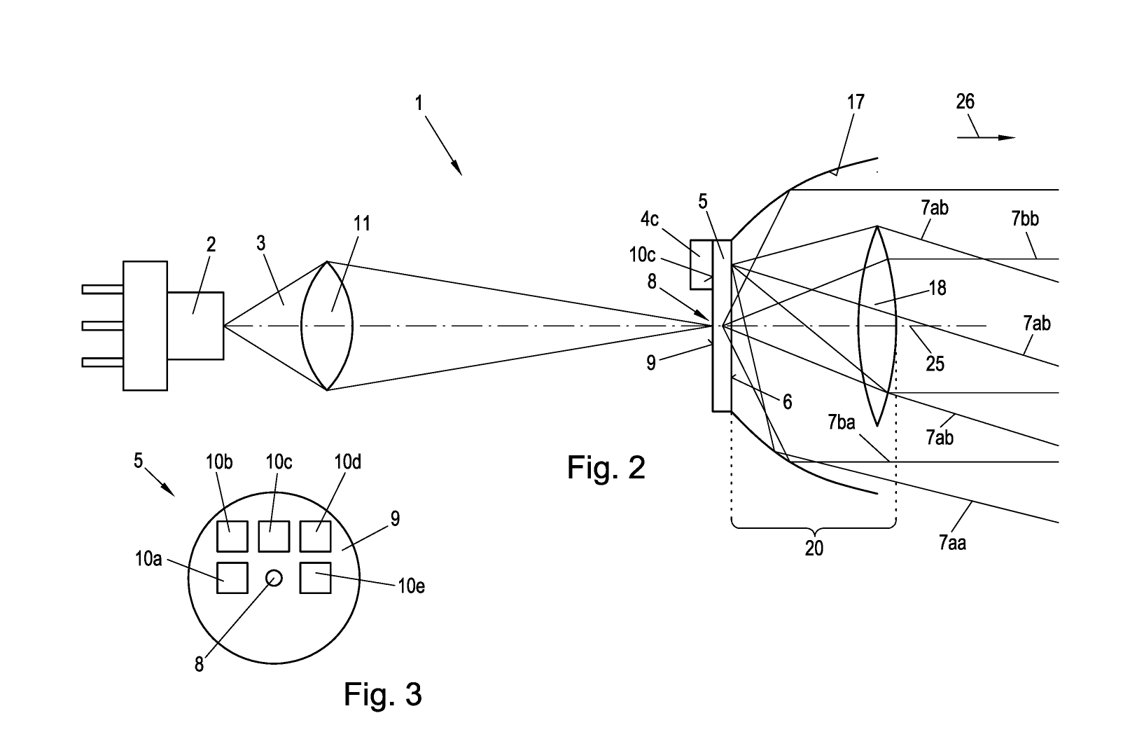

FIG. 2 shows a second lighting device 1 according to various embodiments, which is constructed in a manner comparable to that in accordance with FIG. 1 e.g. as far as the operation of the phosphor element 5 is concerned. Generally, the same reference signs relate to the same parts or parts having the same function and reference is always also made to the description concerning the respective other figures.

The lighting devices 1 in accordance with FIG. 1 and FIG. 2 differ with regard to the supply with pump radiation only in the arrangement of the LEDs (see below in detail), for which reason only one LED 4c can be discerned in the sectional view in accordance with FIG. 2.

Once again an illumination optical unit 20 is arranged at the emission surface 6 of the phosphor element 5, said illumination optical unit likewise including a reflector 17 and a converging lens 18, but no solid-body optical waveguide. Furthermore, the relative arrangement in accordance with FIG. 2 is such that a part 7aa, 7ab of the illumination light 7, said part being generated in response to the excitation with the LED radiation, is also guided via the reflector 17 (the part 7aa), and respectively through the converging lens 18 (the part 7ab). In the present case, the converging lens 18 is not embodied as a solid body, but rather also has a curved light entrance surface and is arranged at a distance from the emission surface of the phosphor element; a suspension used to mount the converging lens 18 relative to phosphor element 5 and reflector 17 is not illustrated. Alternatively, however, a solid body having a reflectively coated side wall would also be possible.

A part 7ba, 7bb of the illumination light 7, said part being emitted in response to the excitation with the laser radiation 3, is guided (in a manner comparable to FIG. 1) via the reflector 17 and respectively through the converging lens 18, this corresponding to light emission in a high-beam light mode of the motor vehicle headlight. Downstream of the illumination optical unit 20, the illumination light 7ba, 7bb emitted in the high-beam light mode has a main propagation direction 26 parallel to the optical axis 25 of the reflector 17 and is collimated per se (the same also holds true in the case of FIG. 1). By contrast, in a low-beam light mode, excitation is carried out using the LED radiation in such a way that the illumination light 7aa, 7ab emitted in response to this excitation, downstream of the illumination optical unit 20, is tilted with respect to the optical axis 25 of the reflector 17.

FIG. 3 shows the incidence surface 9 of the phosphor element 5 of the lighting device 1 in accordance with FIG. 2 in a plan view, that is to say looking at it perpendicularly along the pump radiation incidence. Firstly the laser irradiation surface 8 is identified on the incidence surface 9. A plurality of LED irradiation surfaces 10a-e are arranged circumferentially around said laser irradiation surface in such a way that the laser irradiation surface 8 is partly enclosed thereby. In the arrangement shown in the present case, five LEDs 4 and correspondingly five LED irradiation surfaces 10a-e are provided (the section in accordance with FIG. 2 extends vertically centrally through the arrangement in FIG. 3).

List of Reference Signs

| | |
|---|---|
| Lighting device | 1 |
| Laser diode | 2 |
| Laser radiation | 3 |
| LEDs | 4 |
| Phosphor element | 5 |
| Emission surface | 6 |
| Illumination light | 7 |
| First part (LED excitation) | 7a |
| Parts thereof | 7aa, 7ab |
| Second part (laser excitation) | 7b |
| Parts thereof | 7ba, 7bb |
| Third part (laser excitation) | 7c |
| Laser irradiation surface | 8 |
| Incidence surface | 9 |
| LED irradiation surfaces | 10a-e |
| Incidence converging lens | 11 |
| Illumination optical unit (first variant) | 15 |
| Solid-body optical waveguide | 16 |
| Reflector | 17 |
| Converging lens | 18 |
| Chief ray | 19 |
| Illumination optical unit (second variant) | 20 |
| Optical axis | 25 |
| Main propagation direction | 26 |

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting device for emitting illumination light, the lighting device comprising:
a light emitting diode configured to emit light emitting diode radiation,
a laser configured to emit laser radiation, and
a phosphor element configured to at least partly convert the light emitting diode radiation and the laser radiation into a conversion light which at least proportionally forms the illumination light,
wherein the light emitting diode, the laser and the phosphor element are arranged relative to one another in such a way that during the operation of the lighting device on an incidence surface of the phosphor element in each case in the time integral the light emitting diode irradiates a light emitting diode irradiation surface with the light emitting diode radiation and the laser irradiates a laser irradiation surface with the laser radiation,
wherein the laser irradiation surface and the light emitting diode irradiation surface are free of overlap.

2. The lighting device of claim 1,
wherein the light emitting diode is provided in direct optical contact with the phosphor element, specifically the light emitting diode radiation therebetween penetrates through at most an intermediate material having a refractive index n≧1.2.

3. The lighting device of claim 1,
which is configured such that during the operation of the lighting device the incidence surface of the phosphor element is only ever irradiated alternatively by the light emitting diode or the laser, that is to say is only ever irradiated with one from the light emitting diode radiation and the laser radiation.

4. The lighting device of claim 1,
wherein the light emitting diode is one of a plurality of light emitting diodes, each light emitting diode of which during the operation of the lighting device on the incidence surface irradiates a respective light emitting diode irradiation surface with respective light emitting diode radiation, wherein the light emitting diode irradiation surfaces at least partly enclose the laser irradiation surface as viewed in a plan view of the incidence surface.

5. The lighting device of claim 1, further comprising:
an illumination optical unit, which is arranged on an emission surface of the phosphor element and has a solid body which is transmissive in its volume and in which as optical waveguide a first part of the illumination light is guided away from the emission surface, wherein the illumination optical unit furthermore has a reflector formed on the inner side of the solid-body optical waveguide in such a way that the reflector is a concave mirror, wherein a second part of the illumination light emitted at the emission surface is reflected at the reflector.

6. The lighting device of claim 5,
an illumination optical unit, which is arranged on an emission surface of the phosphor element and has a solid body which is transmissive in its volume and in which as optical waveguide a first part of the illumination light is guided away from the emission surface, wherein the illumination optical unit furthermore has a reflector formed on the inner side of a surface of the solid-body optical waveguide, in such a way that the reflector is a concave mirror, wherein a second part of the illumination light emitted at the emission surface is reflected at the reflector.

7. The lighting device of claim 5,
wherein the illumination optical unit additionally has a converging lens, through which a third part of the illumination light penetrates, said third part being emitted at the emission surface at smaller emission angles than the second part of the illumination light, said second part being reflected at the reflector, wherein the third part of the illumination light is focused.

8. The lighting device of claim 5,
wherein the first part of the illumination light is generated in response to an excitation of the phosphor element by the light emitting diode radiation, and the second part of the illumination light is generated in response to an excitation of the phosphor element by the laser radiation.

9. The lighting device of claim 1, further comprising:
an illumination optical unit, which is arranged on an emission surface of the phosphor element and has as reflector a concave mirror, at which both a part of the illumination light that is generated in response to an excitation with the light emitting diode radiation and a part of the illumination light that is generated in response to an excitation with the laser radiation are reflected at least proportionally in each case.

10. The lighting device of claim 9,
wherein the illumination optical unit additionally has a converging lens, through which both a part of the illumination light that is generated in response to an excitation with the light emitting diode radiation and a part of the illumination light that is generated in response to an excitation with the laser radiation penetrate proportionally in each case and are focused in the process.

11. A motor vehicle headlight, comprising:
a lighting device, comprising:
a light emitting diode configured to emit light emitting diode radiation,
a laser configured to emit laser radiation, and
a phosphor element configured to at least partly convert the light emitting diode radiation and the laser radiation into a conversion light which at least proportionally forms the illumination light,
wherein the light emitting diode, the laser and the phosphor element are arranged relative to one another in such a way that during the operation of the lighting device on an incidence surface of the phosphor element in each case in the time integral the light emitting diode irradiates a light emitting diode irradiation surface with the light emitting diode radiation and the laser irradiates a laser irradiation surface with the laser radiation, wherein the laser irradiation surface and the light emitting diode irradiation surface are free of overlap.

12. The motor vehicle headlight of claim 11,
wherein the lighting device further comprises:
an illumination optical unit, which is arranged on an emission surface of the phosphor element and has a solid body which is transmissive in its volume and in which as optical waveguide a first part of the illumination light is guided away from the emission surface, wherein the illumination optical unit furthermore has a reflector formed on the inner side of the solid-body optical waveguide in such a way that the reflector is a concave mirror, wherein a second part of the illumination light emitted at the emission surface is reflected at the reflector,
wherein the first part of the illumination light is generated in response to an excitation of the phosphor element by the light emitting diode radiation, and the second part of the illumination light is generated in response to an excitation of the phosphor element by the laser radiation,
wherein the motor vehicle headlight is configured such that the light emitting diode irradiation surface is irradiated with the light emitting diode radiation in a daytime running light mode of the motor vehicle headlight and, accordingly, the first part of the illumination light that is generated in response to this excitation is guided by the solid-body optical waveguide in order at least to support a daytime running light function.

13. The motor vehicle headlight of claim 11,
wherein the lighting device further comprises:
an illumination optical unit, which is arranged on an emission surface of the phosphor element and has as reflector a concave mirror, at which both a part of the illumination light that is generated in response to an excitation with the light emitting diode radiation and a part of the illumination light that is generated in response to an excitation with the laser radiation are reflected at least proportionally in each case,
wherein the motor vehicle headlight is configured such that the light emitting diode irradiation surface is irradiated with the light emitting diode radiation in a low-beam light mode of the motor vehicle headlight, wherein a part of the illumination light that is emitted overall by the lighting device in the low-beam light mode of the motor vehicle headlight propagates with a main propagation direction that is tilted with respect to the optical axis of the reflector.

14. The motor vehicle headlight of claim 11,
wherein the lighting device further comprises:
an illumination optical unit, which is arranged on an emission surface of the phosphor element and has a solid body which is transmissive in its volume and in which as optical waveguide a first part of the illumination light is guided away from the emission surface, wherein the illumination optical unit furthermore has a reflector formed on the inner side of the solid-body optical waveguide in such a way that the reflector is a concave mirror, wherein a second part of the illumination light emitted at the emission surface is reflected at the reflector,
wherein the motor vehicle headlight is configured such that the laser irradiation surface is irradiated with the laser radiation in a high-beam light mode of the motor vehicle headlight, and at least one part of the illumination light generated in response to this excitation is guided at least proportionally via the reflector.

15. The motor vehicle headlight of claim 14,
which is configured such that that part of the illumination light which is generated in response to the excitation with the laser radiation propagates downstream of the reflector with a main propagation direction parallel to the optical axis of the reflector.
